(19) United States
(12) Patent Application Publication
(10) Pub. No.: US 2012/0328713 A1
(43) Pub. Date: Dec. 27, 2012

(54) Articles of Manufacture with Improved Anti-microbial Properties

(76) Inventors: Merle E Olson, Calgary (CA); Nick Allan, Drumheller (CA); Amin Mousa Omar, Edmonton (CA); Justin J Anderson, Edmonton (CA); Patricia L Nadworny, Sherwood Park (CA); Michael W Harding, Rosemary (CA)

(21) Appl. No.: 13/515,633

(22) PCT Filed: Dec. 14, 2010
(86) PCT No.: PCT/CA10/02007

§ 371 Date: Aug. 27, 2012

Related U.S. Application Data
(60) Provisional application No. 61/286,119, filed on Dec. 14, 2009.
(60) Provisional application No. 61/286,119, filed on Dec. 14, 2009.
(60) Provisional application No. 61/346,095, filed on May 19, 2010.

(51) Int. Cl. A01N 59/16; C01G 5/00; A01P 1/00; C01B 11/22

(52) U.S. Cl. 424/618; 423/476; 423/463

(57) ABSTRACT

The invention pertains to methods and compositions for preventing or reducing microbial contamination using a silver (III) periodate as antimicrobial active hi a preferred embodiment the silver (III) periodate is used in a coating upon a medical device or implant to confer coating uniformity and antimicrobial efficacy. Also provided is a method of synthetising a silver (III) periodate in high yield by heating a source of single valency silver ions in water and subsequently combining it with a heated solution comprising persulfate, a by droxide, and a periodate.

### FIELD OF THE INVENTION

This invention relates to a composition, method, and/or system for treating, preventing, or reducing microbial contamination of a medical device. The compositions and methods are also suitable for treating or preventing microbial contamination on any surface (i.e. surfaces used for production, handling, transport, storage, processing, or packaging). The compositions and methods comprise at least one high valency silver-containing compound.

This invention also relates to antimicrobial compositions and use of these compositions with various devices, preferably devices such as medical devices, in which having an antimicrobial property is beneficial.

The invention also relates to articles produced or formed using the antimicrobial compositions of the present invention. For example, these compositions may be used for making or coating articles, such as medical devices.

The invention also relates to coatings and/or ingredients in the manufacture of devices where having an antimicrobial property is beneficial, e.g., a medical device or an implant.

### BACKGROUND OF THE INVENTION

For many years, silver and silver salts have been used as antimicrobial agents. An early medicinal use of silver was the application of aqueous silver nitrate solutions to prevent eye infection in newborn babies. Silver salts, colloids, and complexes have also been used to prevent and to control infection. For example, colloidal metallic silver has been used topically for conjunctivitis, urethritis, and vaginitis.

Additionally, silver is known for antimicrobial use with medical devices, such as catheters, cannulae, and stents. One conventional approach for obtaining antimicrobial medical devices is the deposition of metallic silver directly onto the surface of the substrate, for example, by vapor coating, sputter coating, or ion beam coating. However, these noncontact deposition coating techniques suffer from many drawbacks. These drawbacks include poor adhesion, lack of coating uniformity, and the need for special processing conditions, such as preparation in darkness due to the light sensitivity of some silver salts. One particular drawback of these coatings is that the processes by which the coatings are formed do not adequately coat hidden or enclosed areas, such as the interior lumen of a catheter or stent. Additionally, these methods produce coatings that are very much like metallic silver in that they do not release silver from the coating and require contact with the coating to provide antimicrobial action.

Though high concentrations of silver may be deposited on the substrate, very little free ionic silver is released on exposure to aqueous fluid. As a result, these coatings provide only limited antimicrobial activity. They essentially retard colonization of microbial agents on the surface of the device. However, because they do not release sufficient silver ions into aqueous fluids, they offer little or no protection from bacteria carried into the body upon insertion of the device and do not inhibit infection in the surrounding tissue.

Another method of coating silver onto a substrate involves deposition or electrodeposition of silver from solution. Drawbacks of these methods include poor adhesion, low silver pick-up on the substrate, the need for surface preparation, and high labor costs associated with multistep dipping operations usually required to produce the coatings. Adhesion problems have been addressed by inclusion of deposition agents and stabilizing agents, such as gold and platinum metals, or by forming chemical complexes between a silver compound and the substrate surface. However, inclusion of additional components increases the complexity and cost of producing such coatings.

With many medical devices, it is preferred to have a lubricious coating on the device. Lubricious coatings aid device insertion, reduce the trauma to tissue, and reduce the adherence of bacteria. Another drawback to conventional methods which apply silver and other metals directly onto the surface of a medical device for which a lubricious coating is also desired is that a second, lubricious coating must be applied to the device over the antimicrobial coating, adding to manufacturing cost and time.

Some of these coatings release, to varying degrees, silver ions into the solution or tissue surrounding the substrate. However, activating such coatings often requires conditions that are not suitable for use with medical implants, such as catheters, stents, and cannulae. These conditions include abrasion of the coating surface, heating to a temperature above 180° C., contact with hydrogen peroxide, and treatment with an electric current.

Another conventional approach for obtaining antimicrobial medical devices is the incorporation of silver, silver salts, and other antimicrobial compounds into the polymeric substrate material from which the article is formed. An oligodynamic metal may be physically incorporated into the polymeric substrate in a variety of ways. For example, a liquid solution of a silver salt may be dipped, sprayed, or brushed onto the solid polymer, for example, in pellet form, prior to formation of the polymeric article. Alternatively, a solid form of the silver salt can be mixed with a finely divided or liquefied polymeric resin, which is then molded into the article. Further, the oligodynamic compound can be mixed with monomers of the material prior to polymerization.

There are several disadvantages to this approach. One such disadvantage is that larger quantities of the oligodynamic material are required to provide effective antimicrobial activity at the surface of the device. A second disadvantage is that it is difficult to produce articles that allow for the release of the oligodynamic material because most device polymers absorb little, if any, water to aid in the diffusion and release of the oligodynamic material, resulting in articles that provide only a limited antimicrobial effect.

Yet another approach for obtaining antimicrobial medical devices is the incorporation of oligodynamic agents into a polymeric coating which is then applied to the surface of the article. Typically, an oligodynamic agent is incorporated into the coating solution in the form of a solution or a suspension of particles of the oligodynamic agent. Problems associated with this approach include poor adhesion of the coating to the substrate, settling and agglomeration of the oligodynamic particles, and inadequate antimicrobial activity over time.

Therefore, there is a need for antimicrobial compositions that can be incorporated into articles of manufacture. Further, there is a need for antimicrobial coatings with improved adhesion. There is also a need for antimicrobial compositions that overcome the solubility, settling, and agglomeration problems of conventional oligodynamic compositions. There is also a need for antimicrobial compositions that are stable and are not inactivated in the environment of their intended use.

### SUMMARY OF THE INVENTION

The compositions and methods of the present invention comprise high valency silver ions as the antimicrobial agent. These high valency silver-containing agents are the active agents in antimicrobial compositions. In preferred embodiments of the invention, the high valency silver compounds are one or more silver (III) periodates.

The compositions and methods of the present invention comprise one or more silver (III) periodate compounds or compositions, their methods of synthesis, their use as antimicrobial agents, and articles of manufacture that include one or more of these compounds incorporated into the structure of the article or as a coating or the like thereon.

The compositions and methods of the present invention are also effective in treating and/or eradicating biofilm.

An advantage of the compositions and methods of the present invention is that the high valency silver compounds are thermally stable and are not inactivated when placed in contact with a biological fluid. The silver compounds of the present invention are also not inactivated by the compounds that typically inactivate silver ions, e.g., chlorides, sulphides, sulphates, carbonates, thiosulfates, bromides, iodides, and some biological substances, e.g., urine, feces, mucin, or blood. That is, the silver ions of the present invention retain their antimicrobial activity for periods of time in environments that would typically inactivate other silver containing agents.

Another advantage of the compositions and methods of the present invention relates to the amount of silver present as compared to conventional or known silver containing compositions. The inventors have found that the amount of silver present using certain amounts of silver nitrate is much higher than for silver (III) periodate.

### DETAILED DESCRIPTION OF THE INVENTION

The present invention involves high valency silver compounds and their use as antimicrobial agents. In preferred embodiments of the invention, the high valency silver is a silver (III) periodate. The most preferred compounds are sodium diperiodatoargentate (Na₅H₂Ag(IO₆)₂-x H₂O, where x is typically 13-18), or potassium diperiodatoargentate (K₅H₂Ag(IO₆)₂-8 H₂O or K₃H₄Ag(IO₆)₂-3 H₂O). In some embodiments of the present invention, the high valency silver ions are contained in compounds which also contain iodine

In some embodiments of the invention, described in more detail below, the compounds may be dehydrated or partially hydrated. That is, a silver (III) periodate of the present invention is not anhydrous, nor is it hydrous (fully hydrated), for example Na₅H₂Ag(IO₆)₂-xH₂O, where x is typically 2-6, preferably 4. In some embodiments of the invention, the compounds may be anhydrous.

The present invention also may provide compositions and methods that provide antimicrobial, antibacterial, antiviral, antifungal, or antibiotic activity or some combination thereof. The present invention also may provide compositions and methods that reduce encrustation, inhibit coagulation, improve healing, inhibit restenosis, or impart antiviral, antifungal, antithrombogenic, or other properties to coated substrates.

The compositions and methods of the present invention include providing an active agent that is anti-microbial. The compounds are also effective against biofilms, similar structures, or precursors formed by bacteria, fungi, viruses, algae, mollusks, or parasites, yeasts, and/or other microbes. In some embodiments of the invention, the antimicrobial effectiveness also applies to planktonic microorganisms.

The present invention also may provide compositions that inhibit the growth of microorganisms on surfaces. As described in more detail below, the methods and compositions of the present invention may be used wherever biofilm or similar structures may be found, including but not limited to microorganisms growing and/or floating in liquid environments.

In some embodiments of the invention, the compositions and methods are used for treating a microbial contaminant using an antimicrobial agent comprising high valency silver. The compositions and methods may also include one or more other active agents, including but not limited to at least one additional anti-microbial agent; lubricants; preservatives; dispersants, or combinations thereof. Specific examples of some of these other active agents are disclosed below and in the Examples.

The high valency silver compositions of the present invention may be used with or incorporated in an article where antimicrobial properties are desirable and/or beneficial. Examples include but are not limited to medical and surgical devices and/or environments, such as catheters or implants. Other examples are provided below.

In some embodiments of the invention, the compositions and methods may be used to treat and/or prevent one or more human, animal, or plant diseases, conditions, infections, or contaminations. Typically these diseases and infections, etc., are caused by microbes associated with or residing in the biofilm.

Some embodiments of the invention include an article of manufacture comprising one or more high valency silver composition. In some embodiments of the invention, the high valency silver is used to produce an article having improved anti-microbial characteristics, e.g., a medical device, such as a catheter. Some embodiments of the invention include an article of manufacture comprising one or more high valency silver ions released from a dehydrated silver (III) periodate.

In another aspect, the present invention relates to an article of manufacture which comprises the antimicrobial compositions of the present invention. In one embodiment, the composition is used to form an article or a portion of the article, for example by molding, casting, extrusion, etc. Thus, at least part of the formed article is composed of one or more of the compositions of the present invention, alone or in admixture with other components.

In other embodiments, the active agent, alone or in a composition may be applied to a preformed article or part of an article as a coating. The coated article may be produced, for example, by dipping the article into the composition or by spraying the article with the composition and then drying the coated article. In a preferred embodiment, the compositions are used to coat medical devices. Some embodiments of the invention include a coating, layer, or the like on an article, said coating, etc., comprising one or more high valency silver compounds and imparting improved antimicrobial characteristics to the article or a portion of the article. In these embodiments of the invention, the high valency silver composition may be any form that does not inactivate the silver.

Some embodiments of the invention include attaching, e.g., covalently, or with ionic bonding, a high valency silver composition of the present invention, e.g., silver (III) periodate, to a surface of the article itself.

Some embodiments of the invention include forming a high valency silver composition of the present invention, e.g., a silver (III) periodate, in or on the medical device itself. In these embodiments of the invention, the high valency silver composition may be any form that does not inactivate the silver, including but not limited to a coating, layer, wound dressing, topical wound formulations, or the like. In these embodiments of the invention, the silver (III) periodate may be formed on a surface by oxidizing silver nitrate in the presence of a periodate or iodate.

In some embodiments of the invention, the high valency silver may be incorporated into or onto the packaging, shipping container, food wrapper, or the like.

The compositions and methods of the present invention have applicability in a wide variety of agricultural, industrial, and medical environments, e.g., disinfecting any surface, particularly disinfecting work or processing surfaces (e.g., tables); in antimicrobial coatings; in medical devices and implants, particularly where having an antimicrobial property or characteristic would be beneficial; and in treating human, plant, and animal diseases and conditions.

The compositions and methods of the present invention may be used to treat biofilm in a wide range of environments and places. Treating biofilm, as used herein, refers to contacting a biofilm or similar structure with an anti-biofilm agent wherever biofilm may be found, is expected to be found, or is postulated to be found. One skilled in the art will readily recognize that the areas and industries for which the present invention is applicable is a vast number of processes, products, and places.

In a further aspect, the compositions optionally contain other components that provide beneficial properties to the composition, that improve the antimicrobial effectiveness of the composition, or that otherwise serve as active agents to impart additional properties to the composition. The compositions of the invention are also used as herbicides, insecticides, antifogging agents, diagnostic agents, screening agents, and antifoulants.

In another embodiment, the composition optionally contains additional salts of other antimicrobial metals, such as zinc, gold, copper, cerium, and the like. In yet another embodiment, the composition optionally comprises additional salts of one or more noble metals to promote galvanic action. In still another embodiment, the composition optionally comprises additional salts of platinum group metals such as platinum, palladium, rhodium, iridium, ruthenium, osmium, and the like.

The present invention includes any method of contacting a material, substance, or microorganism with an antimicrobial agent of the present invention. Typical mechanisms of contacting include but are not limited to coating, spraying, immersing, wiping, and diffusing in liquid, powder or other delivery forms (e.g., injection, tablets, washing vacuum or oral).

In some embodiments of the invention, the compositions and methods may include applying the anti-microbial agent to any portion of an article or an ingredient of an article. Further, any structure or hard surface (e.g., tools or machinery surfaces associated with a hospital, home, green house, agricultural center, or for harvesting, transport, handling, packaging, or processing) can be sanitized, disinfected, impregnated, or coated with the anti-biofilm agent of the present invention. In preferred embodiments of the invention, antimicrobial properties may be achieved by contacting an antimicrobially active silver species such as a high valency silver compound within or at the surface of a substrate, such as a medical device or plant material. Exemplary surfaces include but are not limited to aluminum, copper, mild steel, stainless steel, titanium, polymers, glass, on plant surfaces or, more broadly, on any hard surfaces associated with bacterial and fungal contaminants, e.g., wood, concrete, metal, glass, rubber or plastic, including dental implants, and catheters.

High valency silver species of this invention may be produced by any process or reaction that produces high valency silver, specifically a silver (III) periodate. The preferred processes are those that result in high valency silver compositions which are soluble and relatively stable in solution. These processes are well known to those of ordinary skill in the art.

See for example, Cohen and Atkinson, Inorg. Chem. 3(12) 1741-1743 (1964); and Balikungeri, et al, Inorganica Chimica Acta, 22:7-14 (1977).

Compositions of the present invention include any silver containing compound that produces a high valency silver (III) periodate, conventionally formed by the combination of a silver compound, such as silver nitrate or silver oxide, and an iodate or periodate. See examples 1 and 2 for examples of new methods of making the compounds of the present invention. See Example 11 for making dehydrated forms of some of these compounds.

The present invention also provides an improved process for producing the silver containing compounds of the present invention. This new process has been shown to produce a higher yield of product than known methods. See example 2 for a description of making sodium diperiodatoargentate and other similar compounds according to this improved process.

High valency silver, as used herein, refers to a composition containing silver having valent states higher than one, such as, for example, Ag (II) and Ag (III) valent states. The preferred composition is an aqueous solution or solid, more preferably one which readily releases high valency silver-containing ions when contacted by a solvent. The compositions and methods of the invention may be comprised of silver having more than one valent state so that the composition containing the silver species may include multivalent substances. Finally, it is believed that the compositions of the present invention may be comprised of a silver-containing substance or a plurality of silver containing substances that react over time to form other silver containing substances which may exhibit differing antimicrobial properties.

Where the methods or composition comprise at least one silver compound releasing Ag+++, the compound may be selected from the group consisting of, but not limited to silver(III) fluorides [(BaAgF₅, MAgF₄ (M═K, Rb, Cs, Na)], silver (III) periodates, including sodium diperiodatoargentate [Na₅H₂Ag(IO₆)₂.xH₂O] and potassium diperiodatoargentate (K₅H₂Ag(IO₆)₂-8 H₂O or K₃H₄Ag(IO₆)₂-3 H₂O), silver(III) tellurate, silver (III) ethylenebis (biguanide) [Ag(enbigH)₂X where X═SO₄, NO₃, ClO₄ or OH], silver(III) biguanide.

Some embodiments of the invention include a method of making a silver (III) periodate compound comprising heating a source of single valency silver ions; combining the heated single valency silver ions with a heated solution comprising a persulfate, a first hydroxide, and a periodate; allowing an aqueous silver (III) periodate to form, for example, a potassium diperiodatoargentate (III). Some embodiments of the present invention may further include reacting the aqueous silver (III) periodate with a second hydroxide to produce a solid silver (III) periodate (for example, sodium diperiodatoargentate).

In alternative embodiments of the invention, the solid form may be produced by lyophilization, or any other method known to those skilled in the art. For example, the inventors have produced a solid form of K₃H₄Ag(IO₆) using lyophilization.

One skilled in the art will recognize that a silver (III) periodate solution may be the desirable endpoint of the process, or producing the solid form may be the desirable endpoint of the process. One skilled in the art will recognize that each endpoint has its own benefits, e.g., the solid may be better or easier for some incorporation methods (e.g., compression molding with polymers), storage, shipping, and may be less reactive. Conversely, the liquid may be better for coating or incorporation in polymer solutions.

Some embodiments of the invention include a source of single valency silver ions selected from the group consisting of silver nitrate; any silver compound soluble in nitric acid or ammonium hydroxide; any silver insoluble in alcohol; or combinations thereof.

Some embodiments of the invention include heating a source of single valency silver ions from about 20° C. to about 50° C.

Some embodiments of the invention include a persulfate selected from the group consisting of potassium persulfate and sodium persulfate.

Some embodiments of the invention include potassium hydroxide as the first hydroxide.

Some embodiments of the invention include a periodate selected from the group consisting of potassium periodate and sodium periodate.

Some embodiments of the invention include a solution comprising potassium hydroxide present at about 5/6 of the potassium persulfate by weight, and the potassium iodate present at about 1/4 of the potassium persulfate by weight.

Some embodiments of the invention include heating the solution to between about 75° C. and about 87° C.

Some embodiments of the invention include combining the source of single valency silver ions with the solution in a drop-wise manner.

Some embodiments of the invention include combining the source of single valency silver ions with the solution at a controlled flow rate.

Some embodiments of the invention include combining the source of single valency silver ions with the solution initially at a slow stir rate and gradually increasing the stir rate to a higher stir rate.

While not intending to be restricted to a particular stir rate, the inventors have found that the stir rate at the start can be between 500-800 rpm if the experiment is done in a 4 liter Erlenmeyer flask; stirring should be increased to 1800 rpm to 2100 rpm for the last 115^{th} of solution.

One or more of the processes noted above produce a stable silver (III) periodate solution, typically one that is very concentrated. These silver (III) periodate solutions are suitable to use in any circumstance where solutions may be employed, including but not limited to sprays or dips. In some of the embodiments noted above (depending on the starting material), the product is K₅H₂Ag(IO₆).

In some embodiments of the invention, the high valency silver compounds may be produced by forming sodium diperiodatoargentate as follows: An aqueous solution of monovalent silver salt, a divalent silver salt, or a silver complex such as silver nitrate, or silver (II) oxide is generated. Silver nitrate is more preferable if the reaction is carried out under acidic conditions or at close to neutral conditions (i.e. at pH below 7). In preferred embodiments, the oxidizing agent is potassium persulfate (KPS). In preferred embodiments, a periodate or meta-periodate compound is also present in solution (e.g. KI0₄). The resulting reaction forms the sodium diperiodatoargentate, which contains high valency silver.

In another preferred embodiment, the high valency silver compound may be produced by forming potassium diperiodatoargentate as follows: A basic solution (pH controlled by a base such as KOH) contains an iodate or periodate compound (such as KIO₄) is combined with a high oxidation state silver compound such as AgO or oxysilver nitrate. The resulting reaction forms the potassium diperiodatoargentate.

In other embodiments, the composition may also be combined with silver (I, II, or III) oxide, colloidal silver, nanocrystalline silver, or silver zeolite.

The silver compounds may be used in any of the following formats: silver-containing coatings, liquid, powder, capsule, tablet, and similar configurations. In a preferred embodiment of the present invention, active agents are incorporated directly, or may be incorporated by sequentially adding components or precursors of the active agent to the material or substrate, e.g., incorporating a precursor(s) of the active agent in or on the coating. Other forms also include films, sheets, fibers, sprays, and gels. The active agents incorporated into the composition may be used for a variety of applications where there is a need for the presence of an antimicrobial agent, an anti-biofilm agent, and/or a preservative agent. An embodiment of the invention includes the use of a high valency silver ion containing compound, preferably sodium diperiodatoargentate and/or potassium diperiodatoargentate, incorporated into polymers or in a coating, including but not limited to polymers such as polyvinyl chloride, polyurethane, and polydimethylsiloxane or other silicones.

Any polymer may be employed in the present invention, including hydrophilic polymers, hydrophobic polymers, and mixtures of these two types of polymers. The use of hydrophilic polymers is preferred because such polymers have additional benefits. These benefits include increased lubricity for patient comfort, increased absorption of aqueous fluids from the body which aids in the release of oligodynamic ions from the composition, inhibition of bacterial attachment, and improved solubility for some metal salts. Hydrophilic polymers best suited to the invention are those that are soluble in water. The ability to add water to the polymer composition without precipitating the polymer facilitates the addition of water-soluble salts directly to the coating composition. Water facilitates the formation of salt colloids within the polymer composition.

Examples of antimicrobial agents that may be used in combination with the present invention include, but are not limited to: 8-hydroxyquinoline sulfate, 8- hydroxyquinoline citrate, aluminum sulfate, quaternary ammonium, isoniazid, ethambutol, pyrazinamnide, streptomycin, clofazimine, rifabutin, fluoroquinolones, ofloxacin, sparfloxacin, rifampin, azithromycin, clarithromycin, dapsone, tetracycline, erythromycin, ciprofloxacin, doxycycline, ampicillin, amphotericin B, ketoconazole, fluconazole, pyrimethamine, sulfadiazine, clindamycin, lincomycin, pentamidine, atovaquone, paromomycin, diclazaril, acyclovir, trifluorouridine, foscarnet, penicillin, gentamicin, ganciclovir, iatroconazole, miconazole, Zn-pyrithione, heavy metals including, but not limited to, gold, platinum, silver, zinc and copper, and their combined forms including, salts, such as chloride, bromide, iodide, and periodate, and complexes with carriers, and other forms. The preferred antimicrobial agent is biguanide.

Additional inactive ingredients may be optionally incorporated in the formulations or added to the formulation based on the intended use. Those skilled in the art will readily recognize that there are a wide variety of additional ingredients that may be added to a composition of the present invention, including but not limited to emulsifiers, thickening agents, solvents, anti-foaming agents, preservatives, fragrances, coloring agents, emollients, fillers, and the like.

The compositions and methods of the present invention are suitable for treating one or more microbial infections, including but not limited to diseases or conditions caused by Pseudomonads, Xanthomonads, Curtobacterium species, Sclerotinia species, Pythium species, Fusarium species, Botrytis cinerea, Helminthosporium solani, Streptomyces species, Phytophthora species, Rhizoctonia solani, Erwinia species, and Clavibacter species.

The compositions and methods of the present invention are also effective or beneficial in decontaminating, disinfecting, or protecting a wide assortment of environments, locations, or surfaces. The antimicrobial agents of the present invention may be used to treat exemplary surfaces, including but not limited to agricultural surfaces, e.g., greenhouses, irrigation systems, storage facilities, and crates and bins; agricultural tools and equipment, including production equipment involved in harvesting, seeding, pruning, tillage and processing/handling equipment such as conveyor belts, pickers, and cutters; food processing plants, centers, or equipment, including dairy plants, poultry plants, slaughter houses, seafood processing plants, fresh produce processing centers, and beverage processing centers. Other exemplary surfaces include building, environmental, medical, dental, and industrial surfaces. further exemplary surfaces include but are not limited to hospitals, greenhouses, agricultural storage facilities, water systems, ships (e.g., biocorrosion), cables (e.g., biocorrosion), and pipelines (e.g., biocorrosion); and coatings themselves, e.g., paint, stain, and grout; medical devices, e.g., catheters and dialysis machines, or parts thereof; and dental implants and coatings.

The compositions and methods of the present invention are also effective, or expected to be effective, as a preservative for plant-based cosmetics, including but not limited to an ingredient of a cosmetic, or incorporated into the packaging of a cosmetic.

The compositions may be used to coat substrate materials. These coatings may comprise either a single layer or multiple layers. The compositions of the present invention are used alone or in combination with polymer coatings to provide advantageous properties to the surface of the substrate. These compositions are used, for example, to deliver pharmaceutical agents that, for example, prevent infection, reduce encrustation, inhibit coagulation, improve healing, inhibit restenosis, or impart antiviral, antifungal, antithrombogenic, or other properties to coated substrates.

One skilled in the art will recognize that the high valency silver compositions of the present invention may be incorporated into an article, medical device, implant, or the like. As used herein, incorporating refers to using a high valency silver composition, such as silver (III) periodate, in the manufacture of the article, as a coating or layer of the article.

The compositions and methods of the present invention are particularly suited for use with or on a metal, including but not limited to titanium, stainless steel, copper, and aluminum.

The compounds of the present invention may be the anti-microbial agent in any formulation for which it may be desirable to include a silver-based anti-microbial agent.

### Definitions

The following definitions are used in reference to the invention:

One skilled in the art will recognize that a biofilm may be composed of a single species, may be multi-species, homogenous, heterogeneous, and/or may also include other organisms associated with or protected by the biofilm. “Biofilm” as used herein also refers to one or more stages of biofilm development or formation.

During biofilm formation, microbes aggregate with each other or may adhere to a surface, encasing themselves in a self-produced matrix of extracellular polymers. This occurs in a tightly regulated response to environmental cues and results in physiological and genetic diversification of the cells in the biofilm. This cellular diversity is linked to an increase in antimicrobial resistance and tolerance of the microbial population. Because of this, biofilms are thought to be responsible for many chronic or device-related infections that are recalcitrant to personalized antibiotic therapy based on MIC testing.

As used herein, “anti-biofilm agent” refers to any element, chemical, biochemical, or the like that is effective against a biofilm. Typical anti-biofilm agents are those that have antimicrobial, anti-bacterial, anti-fungal, or anti-algal properties. Metal and metal compounds, preferably containing high valency silver, have been shown generally to have antimicrobial properties. In some embodiments of the invention, the anti-biofilm agent is a broad spectrum agent, e.g., having effectiveness or activity against more than one microbial species.

“Incorporating” as used herein refers to any process or composition involving at least one high valency silver-containing compound that results in high valency silver ions being biologically and/or medically available as antimicrobial agents. In preferred embodiments of the invention, the high valency silver ions are not inactivated in a timeframe which renders the active ingredient unable to act as an antimicrobial agent. Typically, the high valency silver will be incorporated in or on a medical device during manufacture of the device or a portion thereof; by including a high valency silver species of the present invention in a coating or layer of the device or a portion thereof; or by incorporating a high valency silver species in a composition that aids the function, use, or insertion of the medical device, e.g., a lubricant or disinfectant.

“Planktonic” as used herein refers to microorganisms growing as floating, single cells, which is part of their life cycle.

“Medical device” as used herein refers to any device, tool, instrument, implant, or the like relating to medicine or the practice of medicine, or intended for use to heal or treat a disease or condition. A medical device of the present invention may be used for the medical benefit of a human or animal. Exemplary medical devices include but are not limited to catheters, cannulae, stents, guide wires, implant devices, contact lenses, IUDs, peristaltic pump chambers, endotracheal tubes, gastroenteric feeding tubes, arteriovenous shunts, condoms, oxygenator and kidney membranes, gloves, pacemaker leads, wound dressings, metallic pins, plates, screws, metallic artificial hips, artificial knees and other joint replacement systems, gels, creams, and ointments.

A medical device of the present invention may be formed in whole or in part of any substance that is suitable for use with a human or animal, including but not limited to any metal, including but not limited to titanium, stainless steel, copper, aluminum, combinations thereof, or the like.

“Surface contamination”, as used herein, refers to microorganisms growing on or relocated to a surface. The microorganisms associated with surface contamination may be actively growing or dormant, but represent a viable inoculum that can reinitiate infection, disease, or other undesirable conditions.

As used herein, “partially hydrated”, “partially dehydrated” or “partially hydrous” silver (III) periodate refers to silver (III) periodate with some waters of crystallization attached, but the silver (III) periodate is neither fully hydrated nor completely dehydrated.

For example, the inventors have found, for dehydrating sodium diperiodatoargentate, that leaving 2-6 water molecules, preferably about 4, provides a partially dehydrated silver (III) periodate having improved functional and antibacterial properties. See Example 11.

Some embodiments of the invention include an article of manufacture comprising one or more high valency silver ions released from a partially dehydrated silver(III) periodate. In some embodiments of the invention, the partially dehydrated silver(III) periodate is used to produce a medical device having improved antimicrobial characteristics.

As used herein, dehydrating refers to removing waters of crystallization from a compound, and hydrating refers to adding waters of crystallization to a compound, wherein the resulting compound has a pre-determined number of attached water molecules. Any method for removing the water molecule(s) may be used, including but not limited to heating (shown in the examples). Any method for adding the water molecule(s) may be used, including but not limited to spraying the material with water, humidifying the material, addition of water droplets, etc.

Material, as used herein, refers to any substance, substrate, or surface on or in which the presence of a microorganism is undesirable. Many examples are provided throughout the specification, including but not limited to metals, polymers, gels, and lubricants.

### EXAMPLES

### Example 1

### Chemical Synthesis of Silver (III) Periodate (Method 1)

It has been known for some time that Ag(III) complex compounds are formed when Ag(I) is oxidized in the presence of a stabilizing ligand. Solid silver (III) periodate, Na₅[Ag^{III}(HIO₆)₂]-xH₂O (s), was synthesized as summarized by the following chemical equation:

The following solid ingredients are dissolved in water: AgNO₃, KOH, KIO₄, and K₂SO₄. The following unbalanced chemical reaction occurs:

Ag⁺(aq)+NO₃⁻(aq)+K⁺(aq)+OH⁻(aq)+IO₄⁻(aq)+S₂O₈²⁻(aq)→K₅Ag^{(III)}H₂(IO₆)₂(aq)+K⁺(aq)+OH−(aq) NO₃⁻(aq)+SO₄²⁻(aq)+SO₄⁻(aq)

Sodium hydroxide is added, and the following reaction occurs: K₅[Ag^{III}(HIO₆)₂](aq)+5NaOH (s)→Na₅[Ag^{III}(HIO₆)₂](s)+5K⁺(aq)+5OH⁻(aq)

The primary change with this reaction from that of Cohen et al. (1964) was the use of potassium instead of sodium as a counter ion, which helps keep the silver (III) periodate in solution, allowing silver oxide and potassium sulfate impurities to be filtered off. The AgNO₃ solution was added drop-wise to a solution of KIO₄, K₂S₂O₈, and KOH.

### Example 2

### Improved Process for Producing Sodium Diperiodatoargentate (Na₅H₂Ag(IO₆)₂.xH₂O, where x=˜13-18, typically 16

This process for manufacturing sodium diperiodatoargentate is an improvement over previous manufacturing methods because it produces a higher yield and is a one-step addition procedure.

Following the methods of Cohen et al., 1964 or Balikungeri et al., 1977 (both cited above) produce yields no greater than 25%, whereas yields obtained with the method described in this example yielded approximately 80% prior to extra recrystallization.

MATERIALS: silver nitrate, 5.8 g; potassium persulfate, 60 g; potassium iodate, 16 g; potassium hydroxide, 50 g; sodium hydroxide, 250 g.

### Process:

Add KOH to 2500 mL ddH₂O. Heat solution to approximately 60° C. Dissolve KIO₄ and K₂S₂O₈ into the solution, and heat until the temperature reaches 80° C., while stirring at maximal speed with an overhead stirrer (˜1800 rpm). Keep the solution at a constant temperature of 80° C. for a sufficient period of time to ensure that the entire solution and the container is at the correct temperature. This forms a persulfate solution.

In a separate flask, dissolve AgNO₃ in 1500 mL ddH₂O and heat to 40° C. Add the AgNO₃ solution to the persulfate/periodate solution at a rate of 9.9 mL/min using, for example, a peristaltic pump system. At this addition rate, the stirring rate is preferably controlled so that the stirring is slow while a low volume of solution is present. This prevents bubbles from forming which would cause the solution to evaporate. As the volume of the solution increases, the stirring needs to be increased as well to ensure good contact between the AgNO₃ and the contents of the flask. Faster stirring prevents side reactions.

The inventors have used a 2.5″ Teflon coated overhead stirrer, maintaining the vortex approximately 1″ above the stirrer; this corresponds, approximately, to about 800 rpm at the start of the addition and about 1800 rpm at the end. The inventors have also found that by the time 600 mL are remaining in the AgNO₃ solution flask, the stirrer should be set to 1800 rpm. Once the addition is complete, the solution is removed from the hotplate and allowed to cool to room temperature. The solution is then filtered using a glass crucible (medium porosity filter) to remove any solid impurities (impurities are typically not observed at this step, but there is a possibility of AgO formation).

The NaOH (250 mg) is then added to the filtered solution, and the solution is cooled to a minimum of 40° C. The cooled solution is then filtered using a glass crucible (medium porosity filter), resulting in a filter cake.

The filter cake is then slurry washed two times with 25 mL ddH₂O. Some compound should be seen going through the filter at the end of the second wash. The solid is then transferred to a 2L beaker, 550 mL ddH₂O or less is added, and the solution is heated to 80° C. A hot filtration is then performed at 80° C., filtering at ½ speed on the filter pump. The inventors have found that it is preferable to complete this filtration step within about 1 minute ±15 seconds.

The hot filtration step results in a solid that should be left at room temperature for 1 hour, and then placed in an ice-water bath for up to 2 hours. This causes the solid to recrystallize.

Once the sample has fully recrystallized, it is filtered using a glass crucible (medium porosity filter), and washed three times with 12 mL ddH₂O. The sample is then spread into a thin layer and allowed to dry overnight. Drying may occur in a fume hood at room temperature, or other drying methods known to those skilled in the art may be used.

At this stage, the result is a high-yield of Na₅H₂Ag(IO₆)₂.xH₂O, with K₅H₂Ag(IO₆)₂.8H-₂O as a possible impurity.

To achieve a higher purity compound (Na₅H₂Ag(IO₆)₂.xH₂O only), additional recrystallizations can be performed one-two times.

The sample is placed in a 1L beaker and an appropriate quantity of ddH₂O is added. The sample is then heated to 80° C., and hot filtered using a glass crucible (medium porosity filter). The resulting solution is then placed at room temperature or in a water bath until the solution temperature reaches 20° C. This causes the solution to recrystallize.

Once the sample has fully recrystallized, it is filtered using a glass crucible (medium porosity), washed two times with minimal ddH₂O (e.g. 10 mL), and allowed to sit under vacuum for a minimum of 2 hours (up to overnight). This results in a higher yield.

The compound may be stored in the dark at room temperature.

### Example 3

### Silver (III) Periodate Efficacy Testing In the Presence of Cl⁻, SO₄²⁻, and PO₄³⁻

Silver (III) periodate was tested for efficacy in water, 1% NaCl, 1% K₂SO₄, and 1% K₂HPO₄ solutions, and compared with silver nitrate. The test solutions were tested against P. aeruginosa ATCC 27853. The challenge time was 30 minutes. Silver (III) periodate and silver nitrate were tested at range of 1.5-200 ppm. Silver (III) periodate was effective at 1.73 ppm, indicating that it was not significantly inactivated by any of the salt solutions during the test period. AgNO₃ was inactivated and was unable to kill at any of the tested concentrations, but was effective at killing all the cells for the entire challenge range with no salt and with 1% K₂SO₄, in the presence of 1% NaCl or 1% K₂HPO₄.

### Example 4

### Silver (III) Periodate Efficacy Testing Against Relevant Clinical Pathogens

The antimicrobial effect of silver (III) periodate and silver nitrate (2000 ppm to 15.62 ppm) in saline was tested against Pseudomonas aeruginosa, Staphylococcus aureus (MRSA), Staphylococcus epidermidis (MRSE), Acinetobacter baumanii, Listeria monocytogenes, Enterococcus faecalis (VRE), Escherichia coli, Candida albicans, Klebsiella pneumonia, Enterobacter aerongenes. The challenge time was 4 hours. MBEC (minimum biofilm eradication concentration) measurements showed that silver (III) periodate had higher killing activity than silver nitrate against most of the tested strains in biofilm form.

### Example 5

### Efficacy of Silver(III) Periodate in Human Serum

The effects of silver (III) periodate and silver nitrate were tested in different dilutions of human serum (0.001%, 0.01%, 0.1%, 1%, 10%, 50%) using the MBECTM P&G assay against relevant clinical human pathogens Escherichia coli, Staphylococcus aureus (MRSA), and Candida albicans. The challenge time was 4 hours. The tested concentration range for the silver compounds was 500 to 7.8 ppm.

When the test was run against Escherichia coli ATCC 25922, results showed that in general, log reductions decreased with the decrease in concentrations of silver (III) periodate. Lower concentrations of silver (III) periodate were affected most by the presence of 0.1% and 0.01% human serum, since they showed lower log reduction than silver nitrate especially at the low tested concentrations.

At human serum concentrations of 50%, 10%, and 0.1%, log reductions decreased significantly with a decrease in the concentration of silver nitrate. There was no effect on the log reduction, regardless of the concentration of silver nitrate, when the concentration of human serum was at 1% or 0.001%.

However, silver (III) periodate log reductions at 50% and 10% human serum remained higher than the silver nitrate even at concentrations as low as 7.8 ppm with a difference of 1.5-2.0 log reduction. In conclusion, at high human serum levels, silver (III) periodate provides better kill of Gram negative microorganisms than silver nitrate regardless of the test compound concentration.

When the test compounds were challenged against Staphylococcus aureus (MRSA) 456, there were no significant differences between the killing activities of silver (III) periodate and silver nitrate at high concentrations of human serum. At 0.1% and 0.01% human serum, there was no significant killing activity for both tested compounds. At 0.001% human serum, silver (III) periodate showed higher log reductions at concentrations 31.25-125 ppm. Silver nitrate had a higher log reduction only at 500 ppm with a two magnitude difference. Generally, silver (III) periodate has more antibacterial activity against Gram positive strains than silver nitrate, taking into consideration the fact that the silver content in silver nitrate is roughly 6 times more than silver (III) periodate.

Candida albicans ATCC 28367 also was challenged with silver (III) periodate and silver nitrate in the presence of different dilutions of human serum. Log reductions were higher when the silver (III) periodate concentration was between 31.25-125 ppm at 10% and 1% human serum. At lower human serum concentrations (0.1%, 0.01%, 0.001%) the silver (III) periodate had higher log reductions at concentrations higher than 125 ppm. Log reductions decreased with a decrease in concentration of silver nitrate for all concentrations of human serum. Log reduction values were generally lower with exposure to the lower concentrations of human serum (1%, 0.1%, 0.01% and 0.001%). In conclusion, silver (III) periodates have more antifungal activity than silver nitrate in the presence of human serum.

### Example 6

### Efficacy of Silver (III) Periodate in Urine

The effects of silver (III) periodate and silver nitrate in different dilutions of urine (0.001%, 0.01%, 0.1%, 1%, 10%, 50%) using the MBEC™ P&G assay were tested against Escherichia coli (ATCC 25922)The challenge time was 4 hours. The tested concentration range for both silver compounds was 500 to 7.8 ppm.

No MBEC cut-off point was observed for silver nitrate or silver (III) periodate at any concentration of urine; all values were greater than 500 ppm.

At urine concentrations of 1.0% or lower, both silver nitrate and silver (III) periodate generated an MBC cut-off point of less than 7.8 ppm. Silver (III) periodate was more effective at a concentration of 50.0% urine compared to silver nitrate (≦7.8 ppm vs. 31.25 ppm respectively). Silver nitrate was more effective at a concentration of 100% and 10% urine compared to silver (III) periodate (62.5 vs. 250, and ≦7.8 ppm vs. 31.25 ppm respectively).

Silver nitrate and silver (III) periodate had approximately equal log reductions at higher compound concentrations (500 and 250 ppm) in all tested concentrations of urine. It was observed that, in general, at compound concentrations of 125 ppm and below, silver nitrate had a larger log reduction in the higher concentrations of urine whereas silver (III) periodate had a larger log reduction at the lower and middle concentrations.

For silver (III) periodate alone, it was observed that at all concentrations, the highest log reduction was seen when treated in one of the middle concentrations of urine, either 10.0% or 1.0%. The log reductions were seen to form a bell curve for concentrations of silver (III) periodate at 125 ppm and below, and with the highest log reduction obtained at 62.5 ppm.

In summary, silver (III) periodates work better in the presence of urine, taking into consideration the silver content difference (roughly 6 times more in silver (III) periodate than in silver nitrate)

### Example 7

### Efficacy of Silver (III) Periodate in Feces

The effects of silver (III) periodate and silver nitrate in different dilutions of feces (1.56%, 3.13%, 6.25%, 12.5%, 25%, 50%) were tested using the MBEC™ P&G assay against Escherichia coli (ATCC 25922). The challenge time was 4 hours. The tested concentration range for both silver compounds was 500 to 7.8 ppm.

MBC data indicated that in the presence of feces, silver nitrate was more effective in comparison to silver (III) periodate when the same concentrations dissolved in nanopure water were used. Higher concentrations of feces showed more inhibition of the both silver compounds. Silver(III) periodate was effective at levels higher than 125 ppm for 50% and 25% feces, 62.5 ppm for 12.5% and 6.25% feces, 31.25 ppm at 3.13% feces and 15.6 ppm at 1.56% feces in water. Silver nitrate was effective at 62.5 ppm in 50% feces, 31.25 ppm in 25% feces, 15.6 ppm in 12.5% feces and at <7.8 ppm for 6.25%, 3.13%, and 1.56% feces.

MBEC data indicated that in the presence of feces, silver nitrate was more effective than silver(III) periodate in higher concentrations of feces but less effective in lower concentrations. Silver(III) periodate was ineffective at the highest tested compound concentration (500 ppm) for concentrations of feces higher than 12.5%, but was effective at 6.25% with 125 ppm, 3.13% at 250 ppm, and 1.56% at 125 ppm.

In summary, silver (III) periodate works better in the presence of feces, taking into consideration that the silver content in silver (III) periodate is roughly 6 times less than in silver nitrate.

### Example 8

### Efficacy of Silver(III) Periodate in Mucin

The effects of silver (III) periodate and silver nitrate in different dilutions of mucin (2.0%, 1.0%, 0.5%, 0.25%, 0.12%, 0.06%) were tested using the MBEC™ P&G assay against Escherichia coli (ATCC 25922)The challenge time was 4 hours. The tested concentration range for both silver compounds was 500 to 7.8 ppm.

Results showed that the lower the concentration of silver nitrate, the lower the log reduction was, regardless of the concentration of mucin. For silver (III) periodate, at lower concentrations of mucin (0.25%, 0.12% and 0.06%), the log reduction was relatively unaffected by the changes in concentration of silver (III) periodate. With the higher concentrations of mucin, log reduction decreased with a decrease in concentration of silver (III) periodate.

With the higher concentrations of mucin (2% and 1%), silver (III) periodate was more effective than silver nitrate. With mucin concentrations of 0.5% and lower, higher concentrations of silver nitrate showed better log reductions than the higher concentrations of silver (III) periodate tested. However, lower concentrations of silver(III) periodate were more effective than the lower tested concentrations of silver nitrate when both were exposed to mucin concentrations of 0.5%, 0.25%, 0.12% and 0.06%.

In conclusion, the antimicrobial activity of silver (III) periodate in the presence of mucin is superior to silver nitrate, taking into consideration the silver content difference in both tested compounds.

### Example 9

### Solubility of Silver (III) Periodates in Water and Saline

Solid Na₅H₂Ag(IO₆)₂.xH₂O made following the method of Example 2 (no recrystallization steps, therefore some +K₅H₂Ag(IO₆)₂.8H₂O may have remained in the sample) was tested for solubility in water and saline following OECD Method 105 (Flask Method). The solubility in distilled water was determined to be 6210 ppm (699 ppm Ag) and the solubility in 0.9% NaCl was 46 ppm (5 ppm Ag).

### Example 10

### Stability of Silver (III) Periodates in Water and Saline

Solid Na₅H₂Ag(IO₆)₂.xH₂O made following the method of Example 2 (no recrystallization steps, therefore some +K₅H₂Ag(IO₆)₂.8H₂O may have remained in the sample) was tested for stability in water and saline following OECD Method III and ASTM E 895-89, except that the solutions were unbuffered. The half-lives determined for each temperature-concentration combination tested are shown below:

| Temp | Initial Conc. | | |
|---|---|---|---|
| (° C.) | (ppm) | Solution | t½ (h) |
| 4 | 9 | dH₂O | 86.7 |
| 24 | 9 | dH₂O | 3.3 |
| 44 | 9 | dH₂O | 0.6 |
| 4 | 90 | dH₂O | 189.9 |
| 24 | 90 | dH₂O | 68.3 |
| 44 | 90 | dH₂O | 3.2 |
| 4 | 45 | 0.9% | 148.4 |
| | | NaCl | |
| 24 | 45 | 0.9% | 15.1 |
| | | NaCl | |
| 44 | 45 | 0.9% | 1.5 |
| | | NaCl | |

K₃H₄Ag(IO₆)₂ (solution) was generated following the methods of Cohen et al., 1964, and tested for stability in water following the same methods. The half-lives determined for each temperature-concentration combination tested are shown below:

| Temp | Initial Conc. | |
|---|---|---|
| (° C.) | (ppm) | t½ (h) |
| 4 | 9 | 3.4 |
| 24 | 9 | 2.1 |
| 44 | 9 | 0.3 |
| 4 | 90 | 94.8 |
| 24 | 90 | 38.4 |
| 44 | 90 | 5.4 |

The half-live of silver (III) periodates in these solutions are substantially longer than typically seen for ionic silver-releasing compounds, particularly in the presence of chloride ions. This indicates that the silver (III) periodate compounds of the present invention exhibit extended antimicrobial activity.

### Example 11

### Process for Making Partially Dehydrated Sodium Diperiodatoargentate and its Characteristics

Fully hydrated sodium diperiodatoargentate was made, ground using a mortar and pestle, and spread in an even thin layer in a pre-heated (120° C.) non-reactive container (e.g. glass or ceramics). The thin layer was necessary to prevent areas of poor heat transfer. The container was then placed in an oven at 120° C. for 15 minutes. After 15 minutes, the sample was removed from the oven and transferred to a sealed container (glass vial), which was then stored in a dessicator in the dark at room temperature to prevent the material from adsorbing water.

Relative to the fully hydrated sodium diperiodatoargentate, the partially dehydrated sodium diperiodatoargentate is darker in color and is a much finer powder (which will be advantageous for incorporation into polymers). The partially dehydrated sodium diperiodatoargentate showed the same level of stability as the fully hydrated compound in the presence of saline, generating a bright orange solution, which is also a characteristic of the fully hydrated sodium diperiodatoargentate.

Analysis of the sample using UV-Vis spectrophotometry indicated that the characteristic peak for sodium diperiodatoargentate at 360 nm was still present, and that the molar extinction coefficient (when corrected for the water loss) was undiminished.

Characterization of the thermal stability of fully hydrated sodium diperiodatoargentate led to the discovery of partially dehydrated sodium diperiodatoargentate. Thermal gravimetric analysis (TGA) of fully hydrated sodium diperiodatoargentate samples was performed under air by ramping the temperature over time (for example of TGA up to 400° C., see below). Samples lost water at 120° C., 220° C., and 350° C., but the samples were found not to retain the solution characteristics of fully hydrated sodium diperiodatoargentate above 120° C.

Isothermal TGA was performed at 120° C. for 5 hours to determine the stability of the compound over time at this temperature. Water was lost initially (in under 10 minutes), but no further water was lost within 5 hours.

This indicates that after the initial water loss, the sample remained stable over time at 120° C. (which will be important for processes such as incorporating sodium diperiodatoargentate into plastics which require sample heating), and that only a certain amount of water should be removed at 120° C., with, for example, 4 molecules of water remaining. It was also determined that if small quantities of water were added to the partially dehydrated sodium diperiodatoargentate, the material can regain the original characteristics of the fully hydrated sodium diperiodatoargentate (including the solid's bright orange color). If the partially dehydrated sodium diperiodatoargentate is only partially rehydrated, it is a paler intermediate color, and has a different XRD spectrum than the original compound (see data below), suggesting that the XRD spectrum obtained may be highly dependent on the quantity of attached waters in the compound.

X-ray diffraction was performed on the original (fully hydrated) sodium diperiodatoargentate and on the sample heated at 120° C., as well as a partially rehydrated sample (as discussed above). It was determined that when the sample was heat treated at 120° C. to generate the partially dehydrated sodium diperiodatoargentate, there was a complete loss of sample crystallinity—an essentially amorphous material was produced. When the samples were heated to higher temperatures, they were found to break down to a variety of other iodates. This indicates that the partially dehydrated sodium diperiodatoargentate is in an amorphous metastable transition state, such that if it is further heated, crystallization occurs to form other, less active, compounds, while if water is added to it, it forms a phase that behaves the same as the original hydrated sodium diperiodatoargentate.

The image below shows the fully hydrated sodium diperiodatoargentate, followed by material heated at 120° C. (partially dehydrated sodium diperiodatoargentate), followed by the partially rehydrated material, followed by the zincite standard included with each sample.

### Conclusions/Implications

Fully hydrated sodium diperiodatoargentate can be heated to 120° C. to make an amorphous metastable transition phase. This partially dehydrated sodium diperiodatoargentate demonstrates the same characteristics as the original compound in solution, including color, behavior in saline, UV-Vis spectra, and antimicrobial activity. Therefore it has potential use in the same applications as solid sodium diperiodatoargentate.

The fine powdery form of the partially dehydrated compound, along with its lower water content, may provide it with improved characteristics, particularly in regards to incorporation into polymers, such as those used for medical devices such as catheters.

### Example 12

### Antimicrobial Efficacy Testing of Partially Hydrated Sodium Diperiodatoargentate

Log reduction and MBEC assays were performed to compare the ability of the fully hydrated sodium diperiodatoargentate and the partially dehydrated sodium diperiodatoargentate to kill Pseudomonas aeruginosa biofilms in 4 hours at test compound concentrations between 1.56 ppm and 200 ppm. At 200 ppm, the partially dehydrated sodium diperiodatoargentate had a significantly higher kill than the fully hydrated sodium diperiodatoargentate (p<0.05). At all other concentrations, there were no significant differences between the two groups. This indicates that the partially dehydrated sodium diperiodatoargentate performs at least as well as the fully hydrated sodium diperiodatoargentate as an antimicrobial agent.

This strong activity, in combination with the lower water content and the more powdery consistency, suggests that partially dehydrated sodium diperiodatoargentate could be an excellent agent for incorporating with/coating polymers.

### Example 13

The compositions of the present invention (including sodium diperiodatoargentate) have been tested, including some tested in field trials, for their effectiveness in combination with other active agents. These agents are suitable for combining with oxysilver nitrate (Agress®); streptomycin; copper hydroxide (Kocide 2000 , DuPont Canada); thiamethoxam (Cruiser Maxx Beans, Syngenta); metalaxyl-M and S-isomer (Cruiser Maxx Pulse (Apron Maxx RTA+Cruiser 5FS—Syngenta); chlorothalonil (Bravo 500, Syngenta); fluazinam (Allegro 500F, Syngenta); carboxylic acid amide (Lance, UFA); and fludioxonil and mancozeb (Maxim MZ PSP).

### Example 14

### Silver(III) Periodate use as a Foliar Spray Against Bacterial Blight on Dry Beans (Phaseolus vulgaris)

Field Preparation and Seeding: Crops were sown in small plots using a randomized complete block experimental design with four replicates. Plots were maintained using conventional practices for the region.

Plots were sprayed with a herbicide (Solo+Basagran Forte) according to label specifications to control weeds. Plots were also hand weeded to remove any remaining weeds. Plots were irrigated with solid set pipe with impact sprinkler heads as needed to promote plant growth and production, as well as encourage disease pressure.

Spray Treatment: Each spray treatment was prepared according to label or manufacturers' recommendations. Each treatment was mixed on a stir plate for 15-minutes and then poured into a 2-L labelled pop bottle. Treatments were used immediately. For silver (III) periodate treatments, 0.64 g was added to 2 L of water, and applied at 0.16 kg/Ha as follows:

A CO₂ backpack sprayer was used to apply each treatment at a rate of 1-L per subplot (four 8-m rows). The sprayer was set at 37 PSI and a 2-nozzle spray wand was used with XR TEEJET 8003VS nozzles. Between each treatment, water was used to rinse out the sprayer to reduce mixing of treatments. The first spray was applied at the early onset of disease symptoms. Additional sprays were performed every 7-14 days depending on environmental conditions and disease pressure.

Data Collection: The disease ratings for bacterial blight on bean incidence and severity were taken and recorded weekly. Incidences were measured as the % of plants infected per subplot. The severity was estimated using a 0-9 scale as the average number of lesions per plant.

Silver (III) periodate foliar spray was combined with oxysilver nitrate plus Cruiser Maxx Bean seed treatment.

### Example 15

### Silver(III) Periodate use as a Fungicidal Seed Treatment and Foliar Spray Against Ascochyta in Peas (Pisum sativum)

Treatment of Seeds: Treatment solutions were mixed for 15 minutes with a magnetic stir bar on a stir plate before applying to seed. Seeds were treated in a rotating drum batch treater with 2.8-mL of treatment solution per 0.7 kg of seed. Once seed was dry, an electronic seed counter counted out each lot of seed needed into small envelopes (884), which were stored in a cooler at 5° C. For silver (III) periodate treatments alone, 0.2 g was added to 40 mL water. For silver (III) periodate+Cruiser Maxx Pulse, 2.8 mL Cruiser Maxx Pulse was combined with 0.216 g silver (III) periodate. 0.7 kg of seed were treated with 2.8 mL of each treatment.

Field Preparation and Seeding: This was performed as in example 14 except each treatment was seeded into 4-row subplots using a 4-row cone seeder with pan drills. Seed were sown 5 cm deep at a density of 44 plants/m² (175,000 seeds/acre). The center two rows were treatment rows and the outer rows were guard rows. Rows were 7-m long and were spaced 30-cm apart.

Spray Treatment: This was performed as in example 14, except that in addition to the silver (III) periodate (used alone), there were foliar treatments with silver (III) periodate+Bravo 500. For this treatment, 16 mL of Bravo 500 and 0.32 g silver (III) periodate were combined in 2 L water.

Plots were tested with water (control); silver (III) periodate seed treatment alone; oxysilver nitrate seed treatment alone; Agress+Cruiser Maxx seed treatment; silver (III) periodate+Cruiser Maxx Pulse seed treatments; Agress+Cruiser Maxx seed treatment and Agress foliar spray; Agress+Cruiser Maxx seed treatments and silver (III) periodate foliar spray; Agress+Cruiser Maxx seed treatment and Bravo foliar spray; Agress+Cruiser Maxx seed treatment and Bravo+Agress foliar spray; and Agress+Cruiser Maxx seed treatments and Bravo+silver (III) periodate foliar spray.

Results: Cruiser Maxx+Agress seed treatment and foliar treatment Bravo+Silver(III) Periodate; and Cruiser Maxx+Agress seed treatment and foliar treatment Bravo+Cruiser Maxx+Agress were the best at reducing disease severity on foliage after two treatment sprays.

### Example 16

### Silver(III) Periodate use as a Fungicidal Seed Treatment and Foliar Spray Against Ascochyta in Chickpeas (Cicer arietinum)

Treatment of Seeds: Treatment of seeds was performed as for Example 15, except that for silver (III) periodate+Cruiser Maxx Pulse, the treatment was formulated as 39 mL Apron Maxx RTA, 2.04 mL Cruiser SFS, and 0.2 g sodium diperiodatoargentate, and 2 kg of seed was treated with 10 mL of each treatment.

Field Preparation and Seeding: This was performed as for Example 15, except the rows were 8-m long, and the plots were not irrigated.

Spray Treatment: This was performed as for Example 15.

Plots were tested with water (control); Cruiser Maxx pulse seed treatment alone; silver (III) periodate seed treatment alone; oxysilver nitrate seed treatment alone; Agress+Cruiser Maxx seed treatment; silver (III) periodate+Cruiser Maxx Pulse seed treatments; Agress+Cruiser Maxx seed treatment and Agress foliar spray; Agress+Cruiser Maxx seed treatments and silver (III) periodate foliar spray; Agress+Cruiser Maxx seed treatment and Bravo foliar spray; Agress+Cruiser Maxx seed treatment and Bravo+Agress foliar spray; and Agress+Cruiser Maxx seed treatments and Bravo+silver (III) periodate foliar spray.

Results: Cruiser Maxx+Agress seed treatment and Bravo foliar spray; Cruiser Maxx+Agress seed treatment and Bravo+Agress foliar spray; and Cruiser Maxx+Agress seed treatment and Bravo+silver (III) periodate foliar spray were the best at reducing disease severity on foliage after each spray treatment.

Cruiser Maxx+Agress seed treatment and Bravo foliar spray, Cruiser Maxx+Agress seed treatment and Bravo+Agress foliar spray; and Cruiser Maxx+Agress seed treatment and Bravo+silver (III) periodate foliar spray had the greatest impact on yield.

### Example 17

### Silver (III) Periodate use as a Fungicidal Foliar Spray Against White Mould on Dry Beans (Phaseolus vulgaris)

Treatment of Seeds: Dry bean seeds were already treated with a fungicidal seed treatment, Apron Maxx RTA and a bactericidal seed treatment, streptomycin. They were then treated with water, Cruiser Maxx Beans and Cruiser Maxx Beans+Agress using methods similar to those described in other examples.

Field Preparation and Seeding: Crops were sown in small plots using a randomized complete block experimental design with four replicates. Plots were maintained using conventional practices for the region.

Spray Treatment: Spray treatment was performed as for example 14. The following additional treatments with sodium diperiodatoargentate were made:

3.5 g Lance+0.32 g silver (III) periodate in 2 L water
4.5 mL Allegro 500F+0.32 g silver (III) periodate in 2 L water

Plots were treated with water (control); Cruiser Maxx seed treatment only; Cruiser Maxx+Agress seed treatment only; Cruiser Maxx+Agress seed treatment and Lance foliar spray; Cruiser Maxx+Agress seed treatment and Allegro foliar spray; Cruiser Maxx+Agress seed treatment and Agress foliar spray; Cruiser Maxx+Agress seed treatment and silver (III) periodate foliar spray; Cruiser Maxx+Agress seed treatment and Lance+Agress foliar spray; Cruiser Maxx+Agress seed treatment and Lance+silver (III) periodate foliar spray; Cruiser Maxx+Agress seed treatment and Allegro 500F+Agress foliar spray; and Cruiser Maxx+Agress seed treatment and Allegro 500F+silver (III) periodate foliar spray.

Based on this report, silver (III) periodate can be used as a seed treatment with peas (Pisum sativum), and chickpeas (Cicer arietinum). It can be used as a foliar spray with dry beans (Pinto beans—Phaseolus vulgaris), peas, and chickpeas.

It may also be used with other pulse crops such as soybeans and lentils.

Potassium diperiodatoargentate is also suitable for use in the same purposes as tested here, and might even be a better choice, since it is generated in, and fairly stable as, a solution.

### Example 18

This and the following examples show the effectiveness of sodium diperiodatoargentate as an antimicrobial active agent in pulse crops.

Silver (III) periodate was tested as a bactericidal foliar spray treatment against bacterial speck (Pseudomonas syringae pv. tomato) in tomatoes (Lycopersicon esculentum).

Preparation of Tomato Seed, Preparation of Field, Seeding, Plot Maintenance: Tomato seeds were sown into 24, 50-plug trays in ProMix growing medium (one seed per plug) and were grown in the hoophouse 5 weeks. The trays were watered daily or twice daily as needed.

Crops were sown in small plots using a randomized complete block experimental design with four replicates. Plots were maintained using conventional practices for the region. An insecticide (Sevin XLR) was applied after 1 month according to label specifications to control a Colorado beetle infestation.

Preparation of Spray Treatment Solutions and Inoculum: Each treatment solution was mixed thoroughly on a magnetic stir plate for 15 minutes and then poured into a 2-L labelled pop bottle. Treatments were sprayed immediately, and not stored overnight. For the silver (III) periodate only treatment, 0.64 g was dissolved in 2 L water. For a Dithane DG+Silver(III) periodate treatment, 25 g of Dithane DG and 0.64 g of silver (III) periodate were combined in 2L water. Foliar applied silver (III) periodate was applied at 0.16 kg/Ha. Other products were applied according to label specifications.

Inoculum was prepared by growing P. syringae pv. tomato in two 1.5-L flasks of nutrient broth on the shaker overnight. The inoculum was diluted to 6-L the next day and poured into three 2-L pop bottles and sprayed onto tomato plants at bud stage using a CO2 backpack sprayer as described below. The inoculum was sprayed in when it was cool out −<20° C. (in the evening).

Spray Treatment Procedure: A CO₂ backpack sprayer was used to apply the inoculum. Similarly, each treatment was sprayed with the CO2 sprayer at a rate of 1-L per subplot (two 7 m rows). The sprayer was set at 37 PSI and a 2 nozzle wand was used with XR TEEJET 8003VS nozzles. Between each treatment, water was used to rinse out the sprayer to reduce mixing of treatments. The first treatment was applied approximately two weeks after inoculation. Additional sprays were performed every 7-14 days depending on environmental conditions and disease pressure.

Data Collection: The disease ratings for speck incidence and severity were taken and recorded weekly. Incidences were measured as the % of plants infected per subplot. The severity was estimated using a 0-5 scale as the average number of lesions per leaf in a 2-m section of treatment rows. Disease incidence and severity was also recorded on the fruit in the final disease rating.

The following treatments were compared: water only (control); oxysilver nitrate (half and full dose); silver (III) periodate; Kocide 2000; Dithane DG; Kocide 2000+Dithane DG; Dithane DG+oxysilver nitrate; and Dithane DG+silver (III) periodate.

Results: Kocide 2000, silver (III) periodate, and oxysilver nitrate were the best at reducing disease severity on foliage after three treatment sprays.

### Example 19

Silver (III) periodate was tested as a bactericidal foliar spray treatment against bacterial canker (Clavibacter michiganensis pv. michiganensis) in tomatoes (Lycopersicon esculentum).

See Example 18 for Preparation of Tomato Seed; Preparation of Field; Seeding; Plot Maintenance; Preparation of Spray Treatment Solutions and Inoculum; Spray Treatment Procedure; and Data Collection.

Results: Silver (III) periodate, Dithane DG+silver (III) periodate, and Dithane DG were the best at reducing disease severity on foliage after two treatment sprays. Water, oxysilver nitrate (full dose) and silver (III) periodate were the best at reducing disease severity on foliage after three treatment sprays.

### Example 20

Silver (III) periodate was tested as a bactericidal foliar spray treatment against bacterial canker (Clavibacter michiganensis pv. michiganensis) in tomatoes (Lycopersicon esculentum).

See Example 18 for Preparation of Tomato Seed; Preparation of Field; Seeding; Plot Maintenance; Preparation of Spray Treatment Solutions and Inoculum; Spray Treatment Procedure; and Data Collection.

Results: Oxysilver nitrate (high dose), and Dithane DG+Silver (III) periodate were the best at reducing disease severity on foliage after two treatment sprays. Oxysilver nitrate (low and high dose) and Dithane DG+silver (III) periodate were the best at reducing disease severity on foliage after three treatment sprays.

### Example 21

Silver(III) periodate was tested as a foliar spray treatment fungicide against bacterial spot in tomato.

Preparation of Seed, Preparation of Field, Seeding, Plot Maintenance: Tomato transplants cultivar H9909 were transplanted using a mechanical transplanter at a rate of 3 plants per metre. Rows were spaced 1.5 m apart. Each treatment plot was 7 m long and consisted of one twin-row. The trial was setup as a randomized complete block design, with 4 replications per treatment. Revus was applied on June 12 and 22 for late blight protection. Admire was applied for Colorado potato beetle control. The trial was irrigated using a drip irrigation system as required during the growing season.

Preparation of Spray Treatment Solutions and Inoculum: The trial was inoculated with bacterial spot twice.

Spray Treatment Procedure: Treatments were applied 7 times over two months using a hand-held CO₂ sprayer (35 psi) with ULD 120-02 nozzles and water volume of 200 L/ha.

Data Collection: The number of leaves with bacterial spot lesions on five plants per plot was counted at 3 different times. Disease severity was also rated using a scale of 0 to 3. Tomatoes were harvested from a 2 m section of each plot. Red fruit, green fruit, and rots were separated and weighed. Fifty green and fifty red fruit were randomly selected and assessed for incidence of bacterial spot and speck.

The treatments compared were water (control), oxysilver nitrate, silver (III) periodate, Dithane, Kocide 2000, Dithane DG 75+Kocide 2000, oxysilver nitrate+Dithane, and silver (III) periodate+Dithane, Serenade Max, and Serenade Max+oxysilver nitrate.

Results: There were no differences among treatments for the total tomato yield or green tomato yield. Serenade Max had more rotten tomatoes than the other treatment groups except Serenade Max+oxysilver nitrate. No phytotoxicity was observed on the tomato plants.

### Example 22

Silver (III) periodate was tested as a foliar spray treatment fungicide against bacterial speck in tomato.

See Example 22 for Preparation of Tomato Seed; Preparation of Field; Seeding; Plot Maintenance; Preparation of Spray Treatment Solutions and Inoculum; Spray Treatment Procedure; and Data Collection.

The treatments compared were water (control), oxysilver nitrate, silver (III) periodate, Dithane, Kocide 2000, Dithane DG 75+Kocide 2000, oxysilver nitrate+Dithane, and silver (III) periodate+Dithane, Serenade Max, and Serenade Max+oxysilver nitrate.

Results: The amount of disease that occurred was numerically lower in all treatments than in non-treated controls (not significant except for Kocide). No phytotoxicity was observed on tomato plants. Silver (III) periodate did not have statistically different levels of bacterial speck (number of infected leaves) or disease severity ratings than the standard Kocide and Kocide+Dithane.

### Example 23

Silver (III) periodate was tested as a fungicidal foliar spray treatment against alternaria leaf blight (Alternaria brassicicola) and downy mildew (Peronospora paratsitica Lui) in cauliflower (Brassica oleracea var. botrytis) and broccoli (Brassica oleracea var. botrytis), respectively.

Preparation of Seed, Preparation of Field, Seeding, Plot Maintenance: Two trials were conducted in organic soil (pH ≈7.2, organic matter ≈47.2%). Cauliflower and broccoli were seeded into 128-cell Plastomer plug trays in early June and hand transplanted in early July in two rows, 86 cm apart and 9 meter in length, with an in-row spacing of 40 cm. A randomized complete block arrangement with four replicates per treatment was used. Treatments were applied in July and August using a CO2 backpack sprayer equipped with 4 TeeJet D-2 hollow cone nozzles spaced 40 cm apart and calibrated to deliver 250 L/ha at 240 kPa.

If natural infection with Alternaria did not take place at the point that the plants are half grown, the plot was inoculated with 30,000 spores/mL of Alternaria brassicicola in 0.01% Tween 80 solution at the rate of 250 L/ha. This was immediately followed by irrigation to achieve leaf wetness. The plots were treated prior to inoculation.

Preparation of Spray Treatment Solutions and Inoculum: The treatment rate for silver (III) periodate was 0.16 kg/ha. It was also combined (at this rate) with Bravo, which was delivered at 2.5L/ha.

Data Collection: Plants were monitored weekly to determine when lesions were first observed. Plants (15 per rep, randomly selected and marked for continued assessment) were assessed twice during the growing season for number of lesions per leaf. As heads mature, 15 heads per rep in total were harvested and assessed from each experimental unit. The number of Alternaria le sions per leaf were counted. Healthy leaves were counted and trimmed head weights were recorded to indicate marketable yield.

Treatments compared were oxysilver nitrate, silver (III) periodate, Bravo, Bravo+oxysilver nitrate, Bravo+silver (III) periodate, and water (control).

Results: Silver(III) periodate and Bravo+Silver (III) periodate had significantly lower Alternaria lesions per leaf than the check, and had higher harvest weights (not significant) for broccoli.

Silver(III) periodate had higher Alternaria lesions per leaf than the check and other treatments, however silver (III) periodate+Bravo had the lowest Alternaria lesions per leaf

### Example 24

Silver (III) periodate was tested as a fungicidal foliar spray treatment against alternaria leaf blight (Alternaria brassicicola) and downy mildew (Peronospora paratsitica Lui) in cauliflower (Brassica oleracea var. botrytis) and broccoli (Brassica oleracea var. botrytis), respectively.

See Example 23 for Preparation of Tomato Seed; Preparation of Field; Seeding; Plot Maintenance; Preparation of Spray Treatment Solutions and Inoculum; Spray Treatment Procedure; and Data Collection.

Results: Silver (III) periodate and Bravo+silver (III) periodate had significantly lower downy mildew severity indexes than the check.

### Example 25

Silver (III) periodate was tested as a seed treatment on potato seed pieces naturally infested with Fusarium sambucinum (seed piece decay).

Preparation of Seed, Preparation of Field, Seeding, Plot Maintenance: For liquid treatments, potato seed pieces were placed on a plastic tarp and sprayed on all sides and then air dried for an hour at room temperature. 14 kg of seed was treated per treatment. For treatments that combined liquid and powder treatments, the liquid treatment was applied first and the dry powder was applied after the seed was dry. For dry powder treatments, the samples were shaken with the powder in 30 kg bags.

Seed tubers were sown using double-disk potato seeder with 90-cm row spacing. Rows were 6-m long with 20-seed pieces sown per row in a randomized complete block design. Weed control, irrigation and maintenance were performed as needed: The field was treated with Eptam 8E (2.2L/Ac)+Sencor 75 DF (150 g/Ac) before planting. Fertilizer (100 lbs N+50 lbs P) was provided at the time when the fields were hilled. The following spray treatments were performed: Ridomil Gold/Bravo (8.83 mL/10L), Decis 5 EC (50 mL/Ac), Admire (80 mL/Ac), Dithane DG Rainshield (0.44-0.90 kg/Ac), Ridomil Gold/Bravo (8.83 mL/10L), Reglone (1.4L +220L Water+Agral 90)

Preparation of Seed Treatment Solutions and Inoculum: Silver (III) periodate alone solutions were made with 3 g of silver (III) periodate in 300 mL water. For silver (III) periodate with Maxim MZ PSP, 143 g of Maxim MZ PSP was used. Liquid treatments were mixed for 15 minutes with a magnetic stir bar.

Data Collection: Emergence counts—emerged sprouts were counted weekly for 4 weeks after seeding.

Potatoes were monitored weekly for signs/symptoms of disease. Dead plants and non-emergent sprouts were dug up by the potato crew to determine the cause of damage. Total yield and total marketable yield harvested were measured.

The treatments compared were: non-inoculated check water, inoculated check water, Maxim MZ PSP, Manzate, oxysilver nitrate, silver(III) periodate, oxysilver nitrate+Maxim MZ PSP, silver (III) periodate+Maxim MZ PSP, Actinovate, Serenade Max, and Serenade ASO.

Results: Silver (III) periodate+Maxim MZ PSP, Serenade Max, and Inoculated Water had the greatest impact on marketable yield.

### Example 26

Silver (III) periodate was tested as a seed treatment on potato seed pieces infested with Fusarium sambucinum (seed piece decay).

### See Example 25 for Preparation of Tomato Seed; Preparation of Field; Seeding; Plot Maintenance; Preparation of Spray Treatment Solutions and Inoculum; Spray Treatment Procedure; and Data Collection.

Seed was inoculated in a cement mixer with a culture of Fusarium sambucinum and then dried at room temperature.

Results: Maxim MZ PSP and Silver (III) periodate+Maxim MZ PSP had the greatest impact on marketable yield.

### SUMMARY/CONCLUSIONS

Examples 18-25 show that silver (III) periodate (specifically sodium diperiodatoargentate) may be combined with Dithane DG 75 (Dow Agro Sciences); Bravo; Maxim MZ PSP (Syngenta); and Serenade MAX (AgraQuest/Potato Program CDCS).

Silver (III) periodate can be used as a seed treatment with potatoes. It can be used as a foliar spray with tomatoes, cauliflower, and broccoli.

Potassium diperiodatoargentate serves the same purposes as tested here, and might even be a better choice, since it is generated in a solution, and is stable as a solution.

While the invention has been described in some detail by way of illustration and example, it should be understood that the invention is susceptible to various modifications and alternative forms, and is not restricted to the specific embodiments set forth in the Examples. It should be understood that these specific embodiments are not intended to limit the invention but, on the contrary, the intention is to cover all modifications, equivalents, and alternatives falling within the spirit and scope of the invention.

1. An antimicrobial composition comprising a silver (III) periodate.

2. The antimicrobial composition of claim 1 wherein the silver (III) periodate is one or more compounds selected from the group consisting of sodium diperiodatoargentate or potassium diperiodatoargentate.

3. The antimicrobial composition of claim 1 wherein the silver (III) periodate is partially hydrated.

4. The antimicrobial composition of claim 1 further comprising at least one additional active agent.

5. The antimicrobial composition of claim 1 wherein the silver (III) periodate is an ingredient in a coating, spray, dipping solution, polymer, or lubricant.

6. A method of treating a microbial contaminant comprising contacting a microbe with one or more compounds selected from the group consisting of silver (III) periodates, particularly sodium diperiodatoargentate, and potassium diperiodatoargentate.

7. The method of claim 6 wherein the microbial contaminant is a biofilm.

8. The method of claim 6 wherein the compound or compounds are in the form of a coating, spray, dipping solution, polymer, or lubricant.

9. A method of a biofilm eradication comprising contacting a microbe with one or more compounds selected from the group consisting of silver (III) periodate, sodium diperiodatoargentate, and potassium diperiodatoargentate.

10. The method of claim 9 wherein the compound or compounds are in the form of a coating, spray, dipping solution, polymer, or lubricant.

11. An article of manufacture wherein said article comprises an antimicrobial compound selected from the group consisting of silver (III) periodate, sodium diperiodatoargentate, and potassium diperiodatoargentate.

12. The article of manufacture of claim 11 wherein the article is selected from the group consisting of a medical device; packaging, or parts thereof; an agricultural device; a plant or seed spray; and an antimicrobial plant or seed composition.

13. A method of making a silver (III) periodate comprising the steps of:
heating a source of single valency silver ions;
combining the heated single valency silver ions with a heated solution comprising a persulfate, a first hydroxide, and a periodate; and
allowing an aqueous silver(III) periodate to form.

14. The method of claim 13 further comprising reacting the aqueous silver (III) periodate with a second hydroxide to produce a solid silver (III) periodate.

15. The method of claim 13 wherein the silver (III) periodate is selected from the group consisting of sodium diperiodatoargentate (Na₅H₂Ag(IO₆)₂.xH₂O) or potassium diperiodatoargentate (K₅H₂Ag(IO₆)₂.8H₂O).

16. The method of claim 15 further comprising heating said sodium diperiodatoargentate resulting in a partially dehydrated product.

17. One or more silver (III) periodates produced by the process of claim 13, wherein said products exhibit one or more of increased solubility, increased stability, improved anti-microbial activity, and are not inactivated in the presence of various anions.
